(19) United States
(12) Patent Application Publication
(10) Pub. No.: US 2021/0398050 A1
(43) Pub. Date: Dec. 23, 2021

(54) AUTOMATED DETECTION AND RESOLUTION OF SUPPLY CHAIN ISSUES

(71) Applicant: Kinaxis Inc., Kanata (CA)

(72) Inventors: Andrew DUNBAR, Kanata (CA); Chris MURRAY, Kanata (CA); Ryan McCLUSKEY, Kanata (CA); Bob HAUSER, Kanata (CA)

(21) Appl. No.: 17/354,889

(22) Filed: Jun. 22, 2021

Related U.S. Application Data
(60) Provisional application No. 62/705,314, filed on Jun. 22, 2020.

(51) Int. Cl. G06Q 10/06

(52) U.S. Cl. CPC G06Q 10/06315; G06Q 10/06393; G06Q 10/067; G06Q 10/06375

(57) ABSTRACT

A computer-implemented method comprising: detecting, by a processor, an exception in an incoming supply chain data; analyzing, by the processor, the exception; triggering, by the processor, a scenario generator; generating, by the scenario generator, one or more resolution scenarios for the exception; evaluating, by a digital supply chain simulator, each resolution scenario based on a set of target Key Performance Indicators (KPIs); and ranking, by the processor, the one or more resolution scenarios based on the set of target Key Performance Indicators (KPIs).

### CROSS REFERENCE TO RELATED APPLICATIONS

The present application claims the benefit of U.S. Provisional Patent Application No. 62/705,314 filed Jun. 22, 2020, and expressly incorporated by reference in its entirety herein.

### BACKGROUND

In supply chain management, there are productivity challenges caused by large volumes of supply chain data, the complexity of relationships within that data, tedious manual processes required for analyzing the voluminous data to find problems (“exceptions”), and lengthy human-driven trial-and-error processes to correct those exceptions. All of these matters require time and human resources, thereby increasing the costs of managing a supply chain. Furthermore, due to the rapid pace of change in modern supply chains, the time it takes human planners to identify a planning challenge, assess the impact, determine the best resolution option, and implement the decision in their supply chain is often longer than the window of opportunity they have to implement those options. In practice, this leads to missed opportunities to maintain efficiency in their supply chain.

There is a need to address the management of large volumes of supply chain data, the complexity of relationships within that data, the time-consuming manual processes required for analyzing the voluminous data to find problems (“exceptions”), and human-driven trial-and-error processes to correct those exceptions—in an efficient, cost-effective manner. That is, there is a technical challenge in shortening the decision cycle to a practical time-frame that can the maximize the improvement opportunities achieved.

This background information is provided to reveal information believed by the applicant to be of possible relevance to the present invention. No admission is necessarily intended, nor should be construed, that any of the preceding information constitutes prior art against the present invention.

### BRIEF SUMMARY

Disclosed herein are systems and methods that address the management of large volumes of supply chain data, the complexity of relationships within that data, the time-consuming manual processes required for analyzing the voluminous data to find problems (“exceptions”), and human-driven trial-and-error processes to correct those exceptions—in an efficient, cost-effective manner.

The disclosed systems and methods add significant automation to all stages of detecting and resolving supply chain issues, including data analysis, exception detection, exception analysis, and exception resolution. This dramatically reduces the effort required by a user to address these issues, resulting in much faster exception resolution.

In one aspect, a computer-implemented method includes detecting, by a processor, an exception in an incoming supply chain data, analyzing, by the processor, the exception, triggering, by the processor, a scenario generator, generating, by the scenario generator, one or more resolution scenarios for the exception, evaluating, by a digital supply chain simulator, each resolution scenario based on a set of target Key Performance Indicators, and ranking, by the processor, the one or more resolution scenarios based on the set of target Key Performance Indicators.

The computer-implemented method may also further include filtering, by the processor, the one or more resolution scenarios based on a user-defined threshold, either before or after ranking the one or more resolution scenarios.

The computer-implemented method may also include analyzing the exception by: receiving, by the processor, an external signal; updating, by the processor, an enterprise scenario; and triggering, by the processor, a workflow to evaluate the exception.

The computer-implemented method may also include generating the one or more resolution scenarios by: obtaining, by the processor, the scenario generator for each use case; creating, by the processor, a scenario for the scenario generator; providing, by the processor, inputs for the scenario generator; and updating, by the processor, a list of solution scenarios. The scenario generator may be at least one of a mathematical optimizer, a set of authored business rules and a machine learning model.

The computer-implemented method may also include a workflow that is integrated with the digital supply chain simulator to perform a task; integration of the workflow with the digital supply chain simulator may include: creating, by the workflow, the task; sending, by the workflow, the task to the digital supply chain simulator; processing, by the digital supply chain simulator, the task to provide a result; and sending, by the digital supply chain simulator, the result to the workflow. Other technical features may be readily apparent to one skilled in the art from the following figures, descriptions, and claims.

The computer-implemented method may also include: an exception in which store orders lack enough distribution center stock; the workflow is a Business Process Model and Notation workflow that launches an optimization solution generator sub-workflow and a store prioritization solution generator sub-workflow. Other technical features may be readily apparent to one skilled in the art from the following figures, descriptions, and claims.

In another aspect, a computing apparatus includes a processor. The computing apparatus also includes a memory storing instructions that, when executed by the processor, configures the apparatus to detect, by the processor, an exception in an incoming supply chain data; analyze, by the processor, the exception; trigger, by the processor, a scenario generator; generate, by the scenario generator, one or more resolution scenarios for the exception; evaluate, by a digital supply chain simulator, each resolution scenario based on a set of target Key Performance Indicators; and rank, by the processor, the one or more resolution scenarios based on the set of target Key Performance Indicators.

The computing apparatus may also include instructions that further configure the apparatus to filter, by the processor, the one or more resolution scenarios based on a user-defined threshold, either before or after ranking the one or more resolution scenarios.

The computing apparatus may also include where analyzing the exception includes receiving, by the processor, an external signal, updating, by the processor, an enterprise scenario, and triggering, by the processor, a workflow to evaluate the exception.

The computing apparatus may also include generating the one or more resolution scenarios by: obtaining, by the processor, the scenario generator for each use case; creating, by the processor, a scenario for the scenario generator; providing, by the processor, inputs for the scenario generator; and updating, by the processor, a list of solution scenarios. The computing apparatus may also include a scenario generator that is at least one of a mathematical optimizer, a set of authored business rules and a machine learn model.

The computing apparatus may also be further configured to integrate a workflow with the digital supply chain simulator to perform a task; and where integration of the workflow with the digital supply chain simulator may include: creating, by the workflow, the task; sending, by the workflow, the task to the digital supply chain simulator; processing, by the digital supply chain simulator, the task to provide a result; and sending, by the digital supply chain simulator, the result to the workflow. Other technical features may be readily apparent to one skilled in the art from the following figures, descriptions, and claims.

In one aspect, a non-transitory computer-readable storage medium, the computer-readable storage medium including instructions that when executed by a computer, cause the computer to detect, by a processor, an exception in an incoming supply chain data, analyze, by the processor, the exception, trigger, by the processor, a scenario generator, generate, by the scenario generator, one or more resolution scenarios for the exception, evaluate, by a digital supply chain simulator, each resolution scenario based on a set of target Key Performance Indicators, and rank, by the processor, the one or more resolution scenarios based on the set of target Key Performance Indicators.

The computer-readable storage medium, where the instructions may further configure the computer to filter, by the processor, the one or more resolution scenarios based on a user-defined threshold, either before or after ranking the one or more resolution scenarios.

The computer-readable storage medium may also include analyzing the exception by: receiving, by the processor, an external signal; updating, by the processor, an enterprise scenario; and triggering, by the processor, a workflow to evaluate the exception.

The computer-readable storage medium may also include generating the one or more resolution scenarios by: obtaining, by the processor, the scenario generator for each use case; creating, by the processor, a scenario for the scenario generator; providing, by the processor, inputs for the scenario generator; and updating, by the processor, a list of solution scenarios. The scenario generator may be at least one of a mathematical optimizer, a set of authored business rules and a machine learn model.

The computer-readable storage medium may also include a workflow that is integrated with the digital supply chain simulator to perform a task; and where the workflow may integrate with the digital supply chain simulator by: creating, by the workflow, the task; sending, by the workflow, the task to the digital supply chain simulator; processing, by the digital supply chain simulator, the task to provide a result; and sending, by the digital supply chain simulator, the result to the workflow. Other technical features may be readily apparent to one skilled in the art from the following figures, descriptions, and claims.

The computing apparatus may also include an exception that includes store orders lacking enough distribution center stock, and where the workflow may be a Business Process Model and Notation workflow that launches an optimization solution generator sub-workflow and a store prioritization solution generator sub-workflow. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a flowchart in accordance with one embodiment.

FIG. 2 illustrates a flowchart in accordance with one embodiment.

FIG. 3 illustrates a flowchart in accordance with one embodiment.

FIG. 4 illustrates a component of the flowchart in FIG. 1, in accordance with one embodiment

FIG. 5 illustrates a component of the flowchart in FIG. 1, in accordance with one embodiment.

FIG. 6 illustrates a component of the flowchart in FIG. 1, in accordance with one embodiment.

FIG. 7 illustrates a component of the flowchart in FIG. 1 in accordance with one embodiment.

FIG. 8 illustrates a flowchart of an embodiment of operation of a workflow and how the workflow interacts with a Supply Chain Simulator.

FIG. 9 illustrates a workflow in accordance with one embodiment.

FIG. 10 illustrates an embodiment of a Store Prioritization Solution Generator Sub-workflow called from the parent workflow in FIG. 9.

FIG. 11 illustrates an embodiment of an Optimization Solution Generator Sub-Workflow called from the parent workflow in FIG. 9.

FIG. 12 illustrates a system 1200 in accordance with one embodiment.

### DETAILED DESCRIPTION

Before turning to the figures, which illustrate the exemplary embodiments in detail, it should be understood that the disclosure is not limited to the details or methodology set forth in the description or illustrated in the figures. It should also be understood that the terminology is for the purpose of description only and should not be regarded as limiting.

The systems and methods described herein comprise: one or more sources of incoming supply chain data updates; a set of business processes for detecting exceptions in the incoming supply chain data; a mechanism for the automation of the business processes; a mechanism to automatically generate candidate solutions (“scenarios”) for a given exception; a digital supply chain simulation mechanism that assesses how the supply chain will react to potential solution scenarios; a set of key performance indicators (KPIs) and their target values for a healthy supply chain; a mechanism to recommend the best solution among a set of potential solutions based on the KPI targets; and a mechanism allowing a user to deploy the recommended solution.

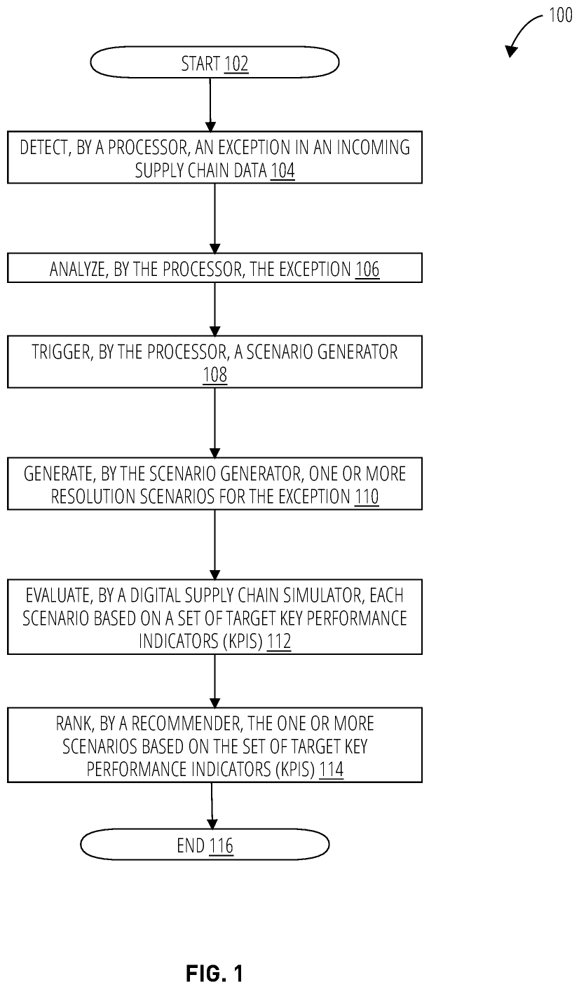

FIG. 1 illustrates a flowchart 100 in accordance with one embodiment.

At block 104, an exception in an incoming supply chain data is detected by a processor. At block 106, the processor analyzes the exception. At block 108, the processor triggers a scenario generator. At block 110, the scenario generator generates one or more resolution scenarios for the exception. At block 112, a digital supply chain simulator, evaluates each scenario based on the impact of each scenario on the supply chain. A supply chain simulator is a tool that allows the modelling of changes that are real or hypothetical (i.e. “what-if”) in a supply chain network in scenarios in order to evaluate the impact of the changes on the supply network and to compare different scenarios. An authentic supply chain simulator replicates the predicted behaviors of the physical supply chain, based on various inputs and algorithms that represent the physical structure and behaviors of the supply chain. Finally, at 114, a recommender ranks the one or more scenarios based on the impact and a set of target Key Performance Indicators (KPIs).

As an example of exception detection at block 104, when new supply chain data enters the system, a Digital Supply Chain Simulator automatically creates a new what-if scenario and uses it to calculate the impact of the new data on the end-to-end supply chain, including updating various supply chain performance metrics. The creation of this scenario triggers the execution of a workflow (pre-defined by the user) to validate the new data. The workflow executes a series of validations to determine if any of the updated supply chain parameters are out of tolerance and, if so, one or more exceptions will be created.

In an example, one of the supply chain metrics of interest to the user is predicted quarterly revenue. The new supply chain data indicates that a number of expected supply orders are now going to be delivered later than expected. The Digital Supply Chain Simulator computes a revenue metric that will be lower than previously expected by 12% since the delayed supply orders will result in manufacturing delays such that some amount of product cannot be shipped before the end of the quarter. The user has previously defined a workflow to check for changes to predicted quarterly revenue and to raise an exception if it drops by more than 10%. The workflow links the exception to the what-if scenario so that subsequent steps in the process can refer back to the data that caused the exception.

When an exception is detected, a second workflow analyzes the exception at block 106 and generates potential scenarios for its resolution at block 110. With regards to analysis of the exception at block 106, the workflow can use information such as the type of exception, the metric(s) that were out of tolerance to trigger that exception, and the supply chain data items that fed those metrics—in order to generate resolution scenarios based on rules defined by the user at block 110.

Continuing the example, the workflow uses the fact that the revenue metric has dropped, the fact that on-time orders (and other data items) are among the drivers of the revenue metric, and the new and previous values of the changed data (at analysis block 106) to create scenarios (at block 110) that attempt to resolve the exception by considering alternative suppliers for the late items, manufacturing the late goods with alternative parts, manufacturing the late goods using more on-hand inventory than planned, etc.

Once the potential resolution scenarios are created block 110, the Digital Supply Chain Simulator computes the end-to-end supply chain impact of each scenario at block 112, including updated calculations of the key supply chain performance metrics. For example, using the preferred alternative supplier may allow on-time manufacture and delivery, but with the drawback that supply costs increase. Using alternative parts may allow on-time delivery but may also impact delivery of other goods that rely on those parts. Lowering inventory levels may allow on-time delivery but may put next quarter's shipments at risk.

Given the potential resolution scenarios described above, the recommender ranks them based on 1 their new values for the key supply chain metrics at 114.

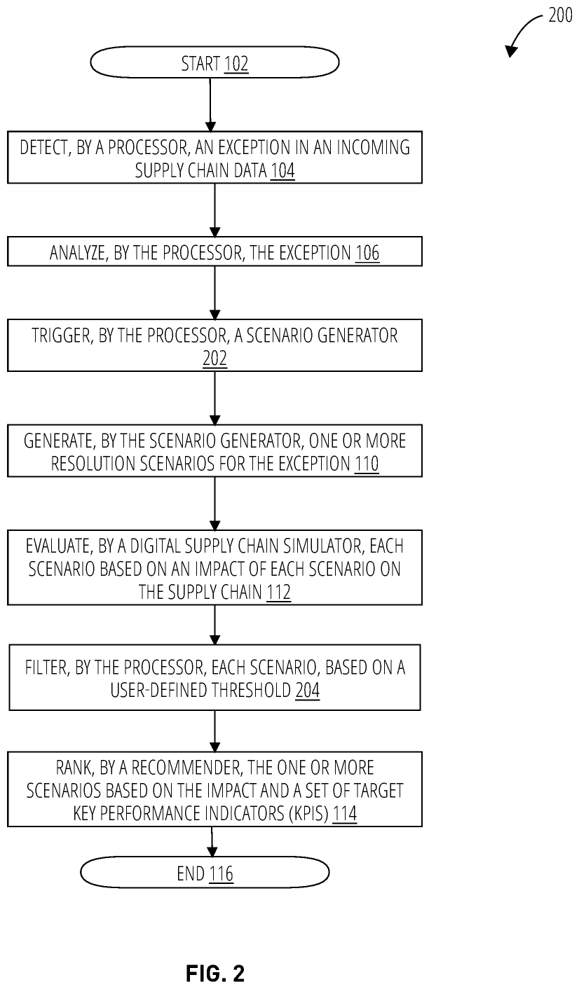

FIG. 2 illustrates a flowchart 200 in accordance with one embodiment.

The steps are identical with those of FIG. 1, with the exception of block 204, which occurs after block 112. At block 204, the various scenarios are filtered, by keeping those scenarios that meet a user-defined threshold, and discarding those scenarios that do not meet the user-defined threshold. The filtered scenarios are then ranked at 114. The user then has the option to select the solution corresponding to the highest-ranked scenario.

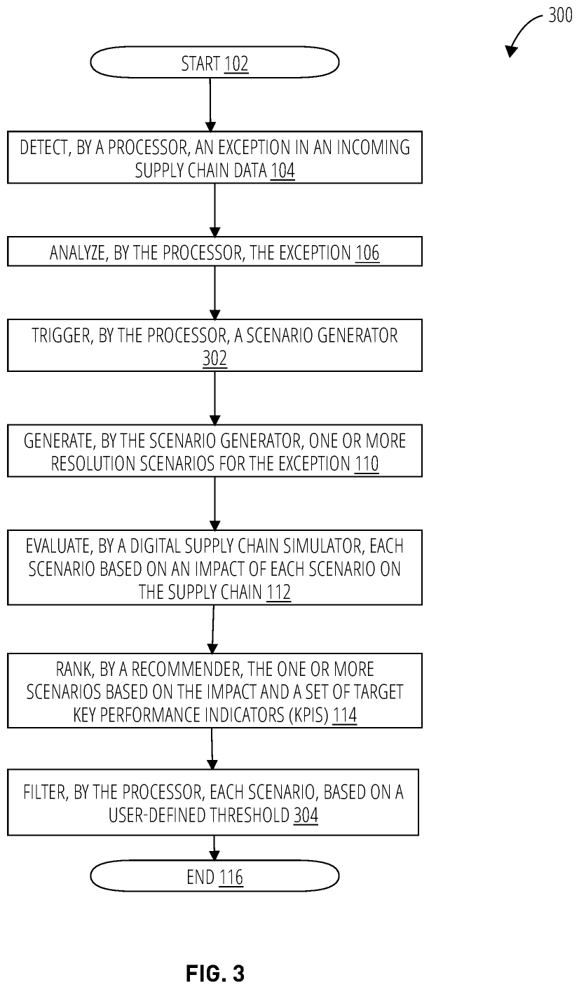

FIG. 3 illustrates a flowchart 300 in accordance with one embodiment.

The steps are identical with those of FIG. 1, with the exception of block 304), which occurs after 114. At block 304, the various scenarios are filtered, by keeping those scenarios that meet a user-defined threshold, and discarding those scenarios that do not meet the user-defined threshold. The filtered scenarios are then ranked at 114. At block 104, an exception in an incoming supply chain data is detected by a processor. At block 106, the processor analyzes the exception. At block 302, the processor triggers a scenario generator. At block 110, the scenario generator generates one or more resolution scenarios for the exception. At block 112, a digital supply chain simulator, evaluates each scenario based on the impact of each scenario on the supply chain. Finally, at 114, a recommender ranks the one or more scenarios based on the impact and a set of target Key Performance Indicators (KPIs) in order to generate resolution scenarios based on rules defined by the user at block 110.

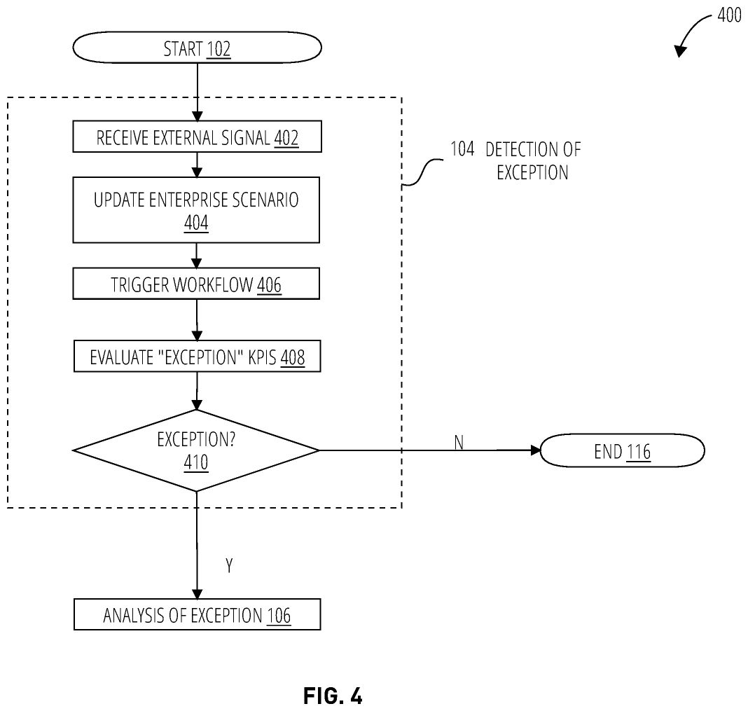

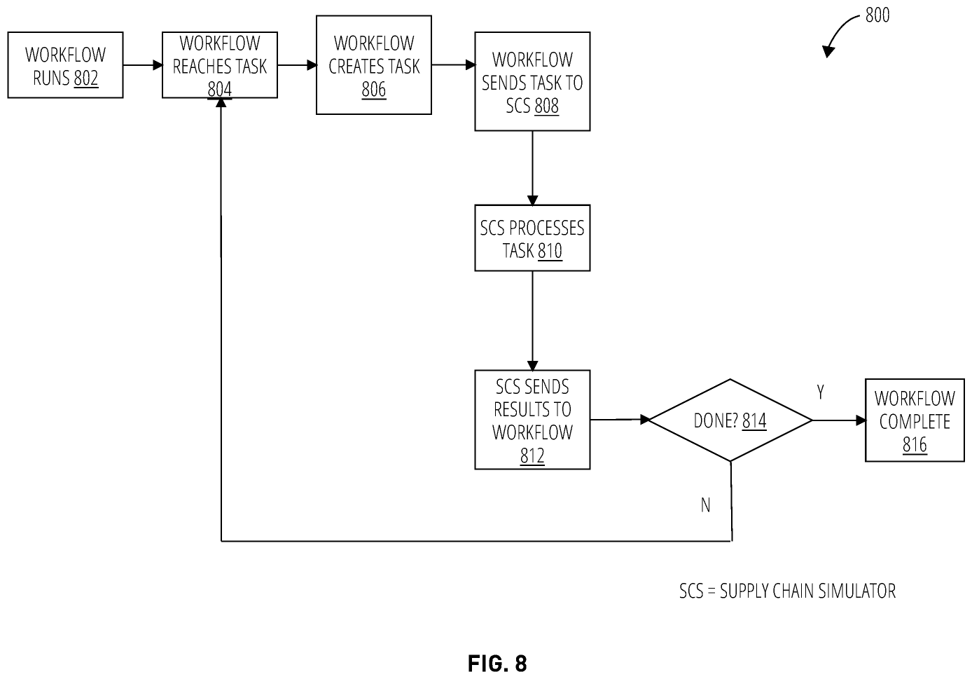

FIG. 4 illustrates a component of the flowchart in FIG. 1, namely, block 104 (detection of an exception) in accordance with one embodiment. The flow diagram 400 starts at 102. An external signal (for example—a distribution center closed due to a weather event), or an Enterprise Resource Planning (ERP) update is received at block 402. An enterprise scenario is updated in a Supply Chain Simulator at block 404, to reflect the changes caused by the external signal. This scenario represents the real world. This in turn may start a “workflow” at block 406, if certain conditions are met (for example, a “distribution center down” workflow may be triggered). The workflow is a resource that is used to customize the exact steps taken (see, for example, workflow execution flow diagram in FIG. 8).

In order to determine if the event is exceptional (for example, such as having a serious impact on revenue or customer satisfaction), the workflow evaluates a set of “exception” KPIs (at block 408) which results in a score. The score is then checked to see if the new state is exceptional at decision block 410. If the state is not exceptional, the processing completes at block 116.

If, on the other hand, the state is exceptional, the system then fathers any relevant data for the exceptional circumstance (the exact data depends on the use case) for further analysis of the exception at block 106, and triggers a solution generator at block 108 as shown in FIG. 1.

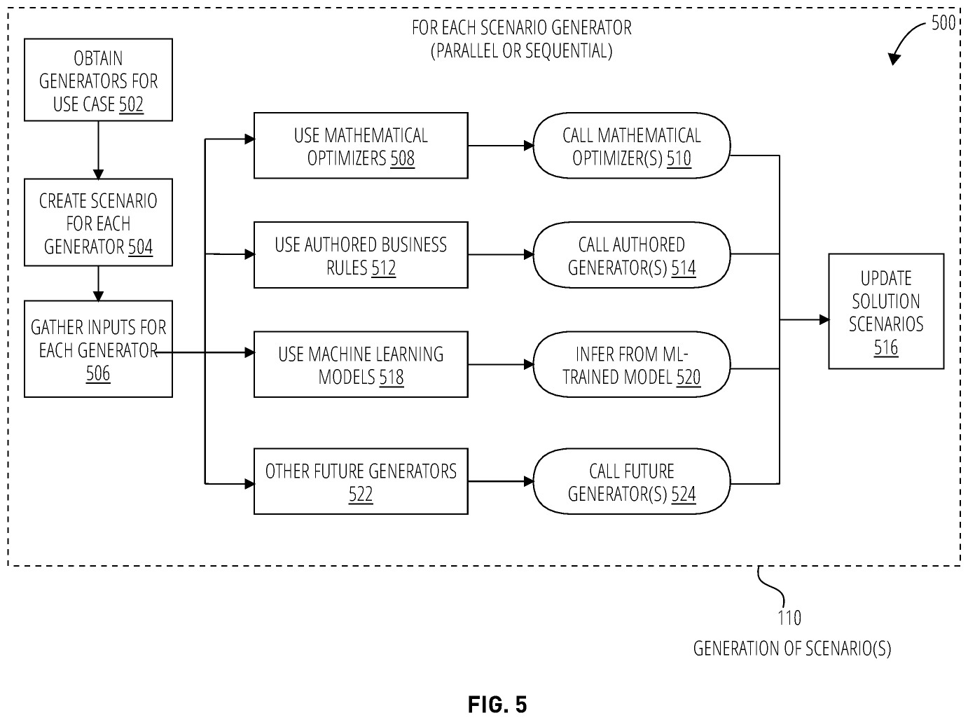

FIG. 5 illustrates a component of the flowchart in FIG. 1, namely, block 110 (generation of one or more scenarios) in accordance with one embodiment.

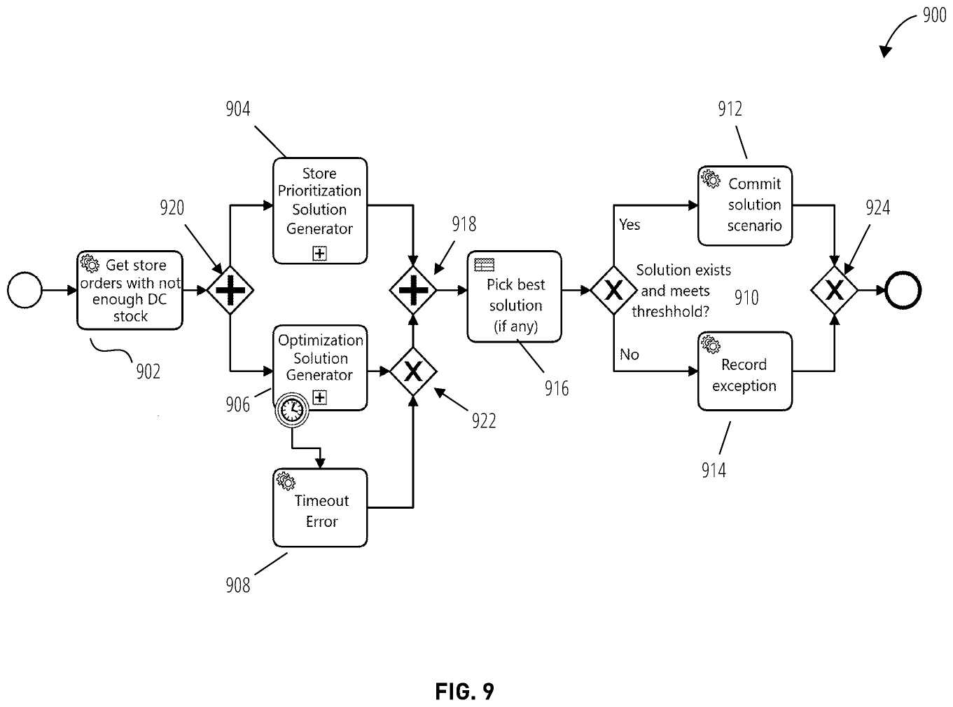

Each use case has different sets of solution generators. Therefore, the workflow obtains relevant generators at block 502. One option is to explicitly include each solution generator in the workflow. Another option is to externally look up solution generators, an example of which, is shown in FIG. 9-FIG. 11.

For each generator, a scenario is created in a simulator to represent the solution at block 504. First, inputs are gathered for each generator at block 506, There are many different ways to generate a solution. For example, one or more business rules may be encoded in the workflow to create solution(s) (block 512). Also, mathematical optimization methods (such as integer programming, linear programming) may be used to create solutions (block 508). Also, inferring from a previously trained ML model may be used to generate new solution and/or recommend previous solutions (block 518). There may be other generation techniques in the future (block 522). The generators may be executed in sequence or parallel or any combination of sequential and parallel. For example, some of authored business rules (block 512) may be run in sequence, while all of the mathematical optimizers (block 508) may be run in parallel, as the latter often take longer to execute.

Each generator may generate 0, 1, or more candidate solution scenarios. These candidate solutions are captured in a list (block 516) for further processing.

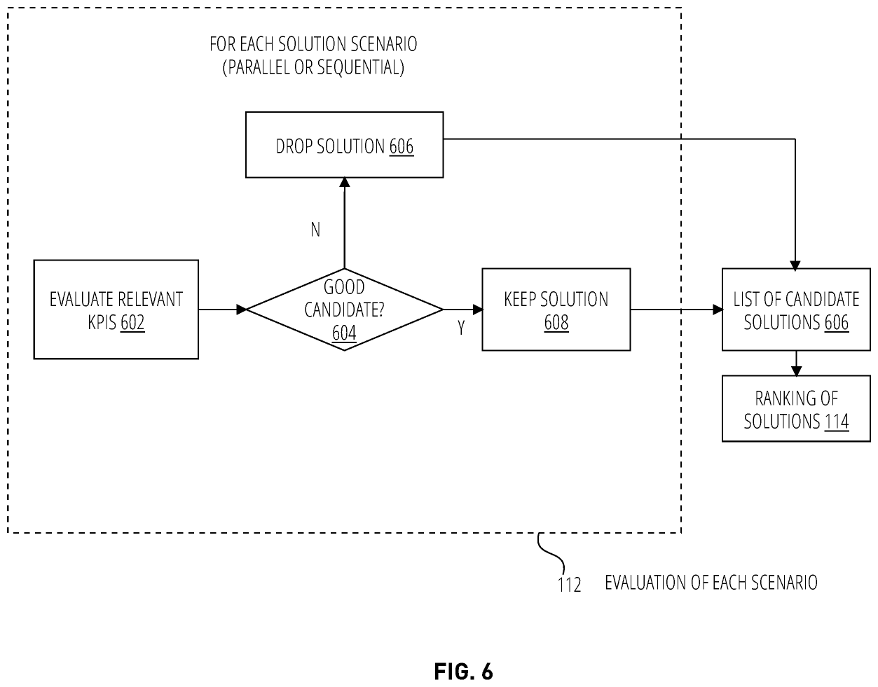

FIG. 6 illustrates a component of the flowchart in FIG. 1, namely, block 112 (evaluation of each scenario) in accordance with one embodiment.

In the embodiment shown in FIG. 6, the input for the evaluation of each scenario (block 112) is a set of solutions, such as the list of solution scenarios generated at block 516 in FIG. 5. Each solution is evaluated to see if it is a good candidate. If not, it is removed. The output of the evaluation of each scenario (block 112) is a list of candidate solutions. The list may be empty if there are no good candidate solutions.

In order to determine if a solution is a good candidate, a set of relevant KPIs (for that candidate solution) is evaluated at block 602. It should be noted that these KPIs may or may not be the same as the “exception” KPIs used in block 408 (of FIG. 4) that are used to determine the presence of an exception. Based on a score calculated from the KPIs, a decision is made regarding the candidate solution at decision block 604. If the solution is a good solution (based on its score), it is kept (block 608) and placed in a list of candidate solutions (block 606); if the solution is not good (based on it score), it is dropped (block 606).

Once the list of candidate solutions (block 606) is fully compiled, each candidate solution is assigned a rank at 114. As noted above, it is possible that the list of candidate solutions (block 606) may be empty.

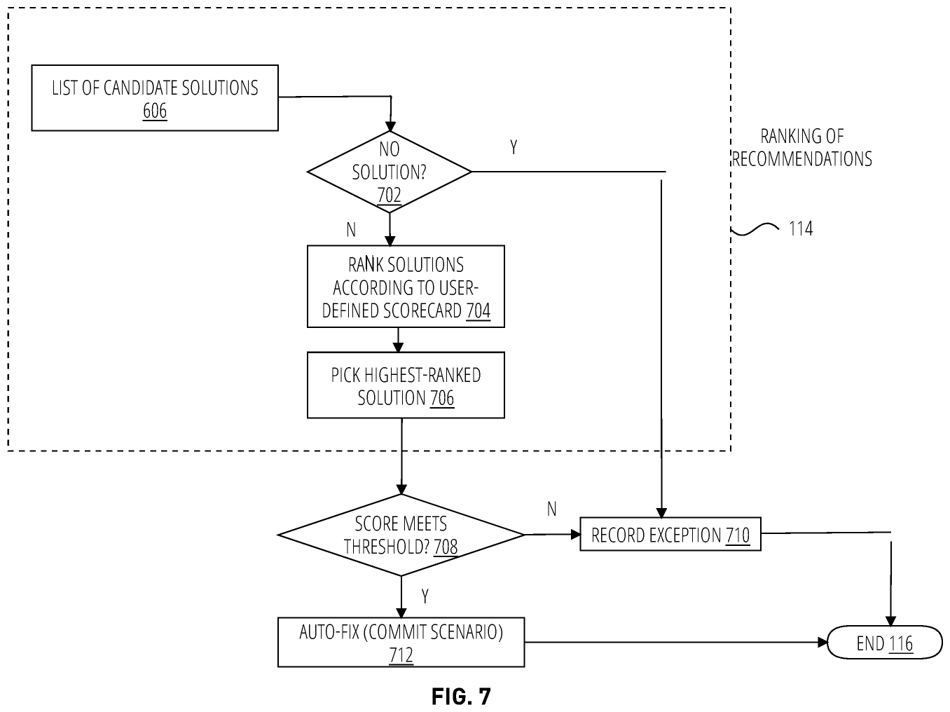

FIG. 7 illustrates a component of the flowchart in FIG. 1, namely, 114 (ranking of recommendations) in accordance with one embodiment.

Once the list of candidate solutions has been compiled (block 608), the list is evaluated at decision block 702. If the list is empty, record an exception (block 710) as there is no solution. If the list is not empty, the solutions are ranked at block 704. In some embodiments, the ranking is according to a user-defined scorecard that reflects the KPIs used in the evaluation of each scenario. The highest-ranked solution is chosen at block 706. There is an optional decision block 708 where if the highest-ranked solution is checked to see if it is within a user-specified or system-generated threshold. If it is, the system may decide to automatically fix (or mitigate) the problem by applying the solution scenario to the main scenario at block 712.

FIG. 8 illustrates a flowchart 800 of an embodiment of operation of a workflow and how the workflow interacts with a Supply Chain Simulator. As the workflow is authored by a user, it can perform a number of different tasks and follow different branches. However, some tasks in the workflow either: require data from a Supply Chain Simulator; or trigger an action in the Supply Chain Simulator (update data, create a scenario, update a scenario, and commit a scenario).

When a workflow (authored business process) is used to run as part of the above process, a workflow service is notified and starts the workflow (block 802). As the workflow proceeds, it may reach a task (at block 804) that either: requires data in the Supply Chain Simulator; or triggers an action in the Supply Chain Simulator. In either case, the workflow creates a task (block 806) to represent the operation and sends the task to the Supply Chain Simulator (block 808). The Supply Chain Simulator performs the action (i.e., retrieves the required data, performs the desired action) at block 810 and sends the results of the action back to the workflow at block 812. Depending on the workflow, a process similar to the above may occur repeatedly with different tasks and inputs (decision block 814) until the workflow reaches the end and completes at block 816.

FIG. 9 illustrates an example of the use of two types of generator for a particular exception. Specifically, FIG. 9 illustrates scenario generation using both an authored business rules generator and a mathematical optimization generator to address a distribution center (DC) stock problem.

FIG. 9 illustrates a simplified authored BPMN workflow 900 that encodes business rules for a use case where there is not enough stock in a DC to handle all store orders. “BPMN” is an abbreviation for “Business Process Model and Notation”, that is a specification used to describe the flow of a business process which can be represented graphically. The execution of the workflow is performed by all of the steps in FIG. 8, where each of tasks 912, 914 and 916 represents some form of task performed by the Supply Chain Simulator, while Store Prioritization Solution Generator (item 904) and Optimization Solution Generator (item 906) are each sub-workflows.

First, the Workflow Service queries the Supply Chain Simulator for all store orders that do not have enough stock in the DC to satisfy them, at block 902. The Workflow Service then, runs two scenario generators in parallel (denoted by 920): 1) Store Prioritization Solution Generator (item 904) that ranks stores based on a user-specified ranking; and 2) Optimization Solution Generator (item 906) which comprises linear programming and integer programming optimization techniques to find a best solution.

Item 920 is an example of an inclusive gateway. There are two types of orientations for an inclusive gateway. One orientation of an inclusive gateway is to have a single ingress link (akin to an input) and multiple egress links (akin to outputs). Item 920 reflects this type of orientation, in that all of the egress paths (i.e. both Store Prioritization Solution Generator and Optimization Solution Generator) are taken and run in parallel. A second orientation of an inclusive gateway is to have a multiple ingress links (akin to inputs) and a single egress link (akin to an output). In this case, the workflow waits until all ingress paths have completed before the egress link is embarked. Item 918 is an example of this type of orientation, where the workflow waits until: the Store Prioritization Solution Generator is completed; and the Optimization Solution Generator is either completed or timed out.

Both the Store Prioritization Solution Generator (item 904) and the Optimization Solution Generator (item 906) are sub-workflows (while the workflow in FIG. 9 is the parent workflow); each sub-workflow outputs one or more solutions at 918. In some embodiments, if the Optimization Solution Generator (item 906) takes too long, it may be timed out (as indicated by the clock icon), resulting in a timeout error (item 908). The sub-workflow Store Prioritization Solution Generator (item 904) maps onto the Authored Business Rules generator 512 in FIG. 5, while the Optimization Solution Generator (item 906) maps onto the Mathematical Optimizers generator 508 in FIG. 5.

Since there can only be one type of output from the Optimization Solution Generator (item 906), item 922 denotes that only one output can be sent to item 918: either a solution generated by the Optimization Solution Generator (item 906), or a timeout error (item 908).

Item 922 is an example of an exclusive gateway, and has two possible orientations. One orientation for an exclusive gateway is to have multiple ingress links (akin to inputs) and a single egress link (akin to output). This is the case at item 922. In such a case, only one of the ingress links needs to finish before proceeding out the egress link. In the case of the Optimization Solution Generator (item 906) and Timeout Error (908), the workflow will continue if an Optimization Solution is generated. or the Optimization Solution is timed out. This orientation is also present at item 924.

A second orientation of an exclusive gateway occurs with a single ingress link (akin to an input) and multiple egress links (akin to outputs). However, only one of the egress links is used—generally by matching a condition against the particular egress link. Decision block 910 (“solution exists and meets threshold?”) is an example of this second type of orientation. If the answer to the question at decision block 910 is “yes”, then one path is taken; if the answer is “no”, then a different path is taken.

Once all the solutions are generated by the Store Prioritization Solution Generator (item 904) and the Optimization Solution Generator (item 906), and output at item 918, the Workflow attempts to pick the best solution at 916, based on business rules, such as checking KPIs, etc. If a solution exists and meets a threshold (decision block 910), then the solution is used at 912. On the other hand, if there is no solution, or the solution does not meet the threshold, then an exception is recorded at 914.

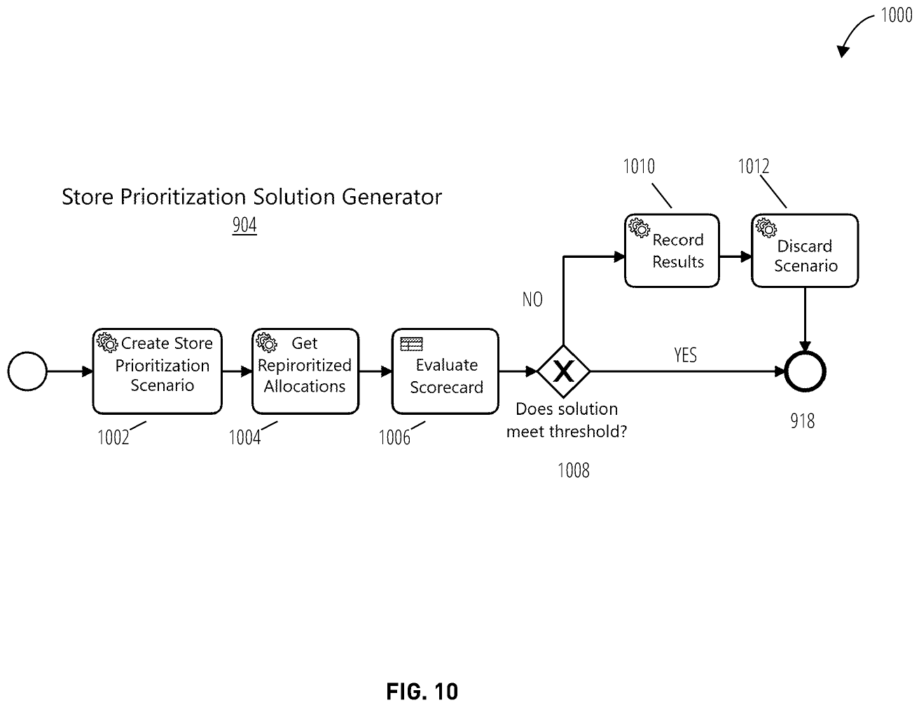

FIG. 10 illustrates an embodiment of a simplified authored BPMN Store Prioritization Solution Generator Sub-workflow 1000 called from the parent workflow 900 (in FIG. 9). In this sub-workflow, a single solution scenario is created in the Supply Chain Simulator at 1002, and based on store prioritization, the sub-workflow reallocates store orders to the DC supply in that scenario in the Supply Chain Simulator at 1004. Block 1006 is a scorecard evaluation step, where KPIs are calculated for the scenario. At block 1008, the scorecard result is compared to a threshold to determine the next step of the sub-workflow. If the scorecard satisfies the threshold, the scenario is passed back up to the parent workflow (item 918 of FIG. 9) as output of the Store Prioritization Solution Generator (item 904). If the solution does not meet the threshold, the results are recorded at 1010 and the scenario is discarded at 1012 (so that no scenario is returned back to the parent workflow).

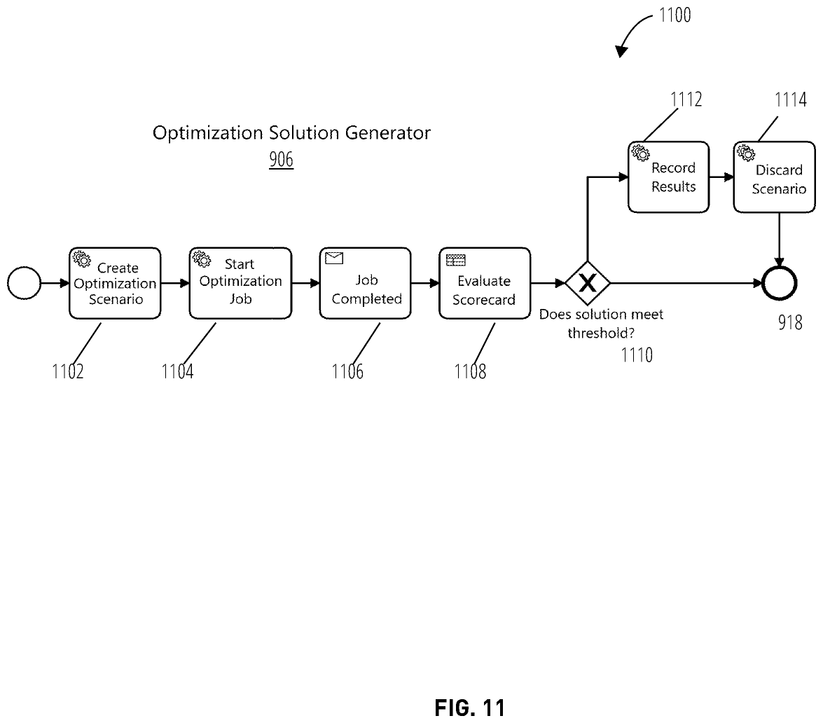

FIG. 11 illustrates an embodiment of a simplified authored BPMN Optimization Solution Generator Sub-Workflow 1100 called from the parent workflow 900 (in FIG. 9).

At block 1102, the sub-workflow first creates a single scenario in the Supply Chain Simulator to store the results of the optimization. The sub-workflow then starts an optimization job in the data platform at 1104. The sub-workflow then starts waiting until the data platform completes the job and sends the “Job Completed” message at item 1106. Similar to Store Prioritization Solution Generator, block 1108 is a scorecard evaluation step, where KPIs are calculated for the scenario. At block 1108, the scorecard result is compared to a threshold to determine the next step of the sub-workflow. If scorecard satisfies the threshold, the scenario is passed back up to the parent workflow (item 918 of FIG. 9) as output of the Optimization Solution Generator. If the solution does not meet the threshold, the results are recorded at block 1112 and the scenario is discarded at block 1114 (so that no scenario is returned back to the parent workflow).

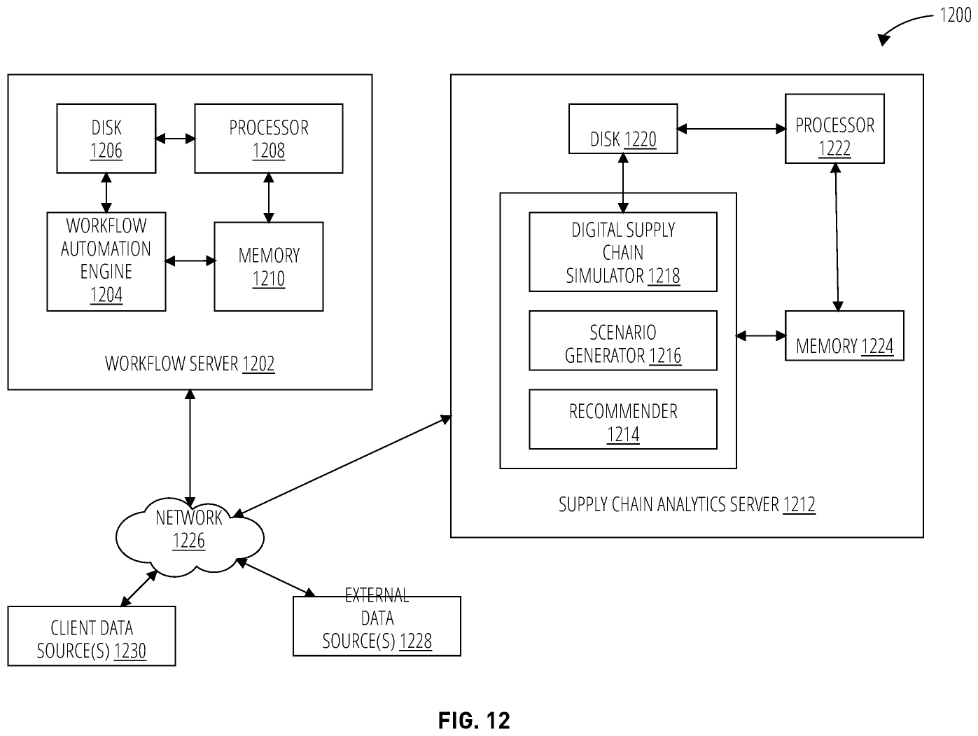

FIG. 12 illustrates a system 1200 in accordance with one embodiment.

System 1200 includes a workflow server 1202, a supply chain analytics server 1212, client data source(s) 1230 and external data source(s) 1228.

Workflow server 1202 can include a memory 1210, a disk 1206, a processor 1208 and a workflow automation engine 1204. While one processor 1208 is shown, the workflow server 1202 can comprise one or more processors. In some embodiments, memory 1210 can be volatile memory, compared with disk 1206 which can be non-volatile memory. In some embodiments, workflow server 1202 can communicate with external data source(s) 1228, client data source(s) 1230 and supply chain analytics server 1212 via network 1226. While client data source(s) 1230 is illustrated as separate from workflow server 1202, client data source(s) 1230 can also be integrated into workflow server 1202, either as a separate component within workflow server 1202, or as part of at least one of memory 1210 and disk 1206.

Supply chain analytics server 1212 can include a memory 1224, a disk 1220, a processor 1222, a digital supply chain simulator 1218, a scenario generator 1216 and a recommender 1214. While one processor 1222 is shown, the supply chain analytics server 1212 can comprise one or more processors. In some embodiments, memory 1224 can be volatile memory, compared with disk 1220 which can be non-volatile memory. In some embodiments, supply chain analytics server 1212 can communicate with workflow server 1202, external data source(s) 1228 and client data source(s) 1230 via network 1226.

System 1200 can also include additional features and/or functionality. For example, system 1200 can also include additional storage (removable and/or non-removable) including, but not limited to, magnetic or optical disks or tape. Such additional storage is illustrated in FIG. 12 by memory 1224 and disk 1220. Storage media can include volatile and nonvolatile, removable, and non-removable media implemented in any method or technology for storage of information such as computer-readable instructions, data structures, program modules or other data. Memory 1224 and disk 1220 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 1200. Any such non-transitory computer-readable storage media can be part of system 1200.

Communication between supply chain analytics server 1212, workflow server 1202, client data source(s) 1230 and external data source(s) 1228 via network 1226 can be over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). Generally, communication between various components of system 1200 may take place over hard-wired, cellular, Wi-Fi or Bluetooth networked components or the like. In some embodiments, one or more electronic devices of system 1200 may include cloud-based features, such as cloud-based memory storage.

Client data source(s) 1230 may implement an “in-memory” database, in which volatile (e.g., non-disk-based) storage (e.g., Random Access Memory) is used both for cache memory and for storing the full database during operation, and persistent storage (e.g., one or more fixed disks) is used for offline persistency and maintenance of database snapshots. Alternatively, volatile storage may be used as cache memory for storing recently-used data, while persistent storage stores the full database.

External data source(s) 1228 may include sources that provide incoming data about events that could affect the supply chain. Some examples include weather events, geo-political risk (labour strikes, demonstrations, etc.), transportation disruptions (road closures, fuel shortages, etc.) and order delivery rescheduling.

Client data source client data source(s) 1230 may provide a variety of primary supply chain data. Examples include: a list of suppliers, a lists of customers, parts, bills of materials (how to build things from parts), orders, demand forecasts, manufacturing schedules, inventory, etc.

Using network 1226, supply chain analytics server 1212 can retrieve data from client data source(s) 1230 and external data source(s) 1228, while communicating with workflow automation engine 1204. The retrieved data can be saved in memory 1224 or disk 1220. In some cases, supply chain analytics server 1212 can also comprise a web server, and can format resources into a format suitable to be displayed on a web browser.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner and can be used separately or in combination.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
detecting, by a processor, an exception in an incoming supply chain data;
analyzing, by the processor, the exception;
triggering, by the processor, a scenario generator;
generating, by the scenario generator, one or more resolution scenarios for the exception;
evaluating, by a digital supply chain simulator, each resolution scenario based on a set of target Key Performance Indicators; and
ranking, by the processor, the one or more resolution scenarios based on the set of target Key Performance Indicators.

2. The computer-implemented method of claim 1, further comprising:
filtering, by the processor, the one or more resolution scenarios based on a user-defined threshold, either before or after ranking the one or more resolution scenarios.

3. The computer-implemented method of claim 1, wherein analyzing the exception comprises:
receiving, by the processor, an external signal;
updating, by the processor, an enterprise scenario; and
triggering, by the processor, a workflow to evaluate the exception.

4. The computer-implemented method of claim 1, wherein generating the one or more resolution scenarios comprises:
obtaining, by the processor, the scenario generator for each use case;
creating, by the processor, a scenario for the scenario generator;
providing, by the processor, inputs for the scenario generator; and
updating, by the processor, a list of solution scenarios;
and wherein:
the scenario generator is at least one of a mathematical optimizer, a set of authored business rules and a machine learning model.

5. The computer-implemented method of claim 1, wherein a workflow is integrated with the digital supply chain simulator to perform a task;
and wherein integration of the workflow with the digital supply chain simulator comprises:
creating, by the workflow, the task;
sending, by the workflow, the task to the digital supply chain simulator;
processing, by the digital supply chain simulator, the task to provide a result; and
sending, by the digital supply chain simulator, the result to the workflow.

6. The computer-implemented method of claim 5, wherein:
the exception comprises store orders lacking enough distribution center stock;
the workflow is a Business Process Model and Notation workflow that launches an optimization solution generator sub-workflow and a store prioritization solution generator sub-workflow.

7. A computing apparatus comprising:
a processor; and
a memory storing instructions that, when executed by the processor, configure the apparatus to:
detect, by the processor, an exception in an incoming supply chain data;
analyze, by the processor, the exception;
trigger, by the processor, a scenario generator;
generate, by the scenario generator, one or more resolution scenarios for the exception;
evaluate, by a digital supply chain simulator, each resolution scenario based on a set of target Key Performance Indicators; and
rank, by the processor, the one or more resolution scenarios based on the set of target Key Performance Indicators.

8. The computing apparatus of claim 7, wherein the instructions further configure the apparatus to:
filter, by the processor, the one or more resolution scenarios based on a user-defined threshold, either before or after ranking the one or more resolution scenarios.

9. The computing apparatus of claim 7, wherein analyzing the exception comprises:
receiving, by the processor, an external signal;
updating, by the processor, an enterprise scenario; and
triggering, by the processor, a workflow to evaluate the exception.

10. The computing apparatus of claim 7, wherein generating the one or more resolution scenarios comprises:
obtaining, by the processor, the scenario generator for each use case;
creating, by the processor, a scenario for the scenario generator;
providing, by the processor, inputs for the scenario generator; and
updating, by the processor, a list of solution scenarios;
and wherein:
the scenario generator is at least one of a mathematical optimizer, a set of authored business rules and a machine learn model.

11. The computing apparatus of claim 7, wherein the apparatus is further configured to integrate a workflow with the digital supply chain simulator to perform a task;
and wherein integration of the workflow with the digital supply chain simulator comprises:
creating, by the workflow, the task;
sending, by the workflow, the task to the digital supply chain simulator;
processing, by the digital supply chain simulator, the task to provide a result; and
sending, by the digital supply chain simulator, the result to the workflow.

12. The computing apparatus of claim 11, wherein:
the exception comprises store orders lack enough distribution center stock;
the workflow is a Business Process Model and Notation workflow that launches an optimization solution generator sub-workflow and a store prioritization solution generator sub-workflow.

13. A non-transitory computer-readable storage medium, the computer-readable storage medium including instructions that when executed by a computer, cause the computer to:
detect, by a processor, an exception in an incoming supply chain data;
analyze, by the processor, the exception;
trigger, by the processor, a scenario generator;
generate, by the scenario generator, one or more resolution scenarios for the exception;
evaluate, by a digital supply chain simulator, each resolution scenario based on a set of target Key Performance Indicators; and
rank, by the processor, the one or more resolution scenarios based on the set of target Key Performance Indicators.

14. The computer-readable storage medium of claim 13, wherein the instructions further configure the computer to:
filter, by the processor, the one or more resolution scenarios based on a user-defined threshold, either before or after ranking the one or more resolution scenarios.

15. The computer-readable storage medium of claim 13, wherein analyzing the exception comprises:
receiving, by the processor, an external signal;
updating, by the processor, an enterprise scenario; and
triggering, by the processor, a workflow to evaluate the exception.

16. The computer-readable storage medium of claim 13, wherein generating the one or more resolution scenarios comprises:
obtaining, by the processor, the scenario generator for each use case;
creating, by the processor, a scenario for the scenario generator;
providing, by the processor, inputs for the scenario generator; and
updating, by the processor, a list of solution scenarios;
and wherein:
the scenario generator is at least one of a mathematical optimizer, a set of authored business rules and a machine learn model.

17. The computer-readable storage medium of claim 13, wherein a workflow is integrated with the digital supply chain simulator to perform a task;
and wherein integration of the workflow with the digital supply chain simulator comprises:
creating, by the workflow, the task;
sending, by the workflow, the task to the digital supply chain simulator;
processing, by the digital supply chain simulator, the task to provide a result; and
sending, by the digital supply chain simulator, the result to the workflow.

18. The computer-readable storage medium of claim 17, wherein:
the exception comprises store orders lack enough distribution center stock;
the workflow is a Business Process Model and Notation workflow that launches an optimization solution generator sub-workflow and a store prioritization solution generator sub-workflow.
